(19) United States
(12) Patent Application Publication
(10) Pub. No.: US 2026/0145958 A1
(43) Pub. Date: May 28, 2026

(54) SYSTEM FOR PREPARING ALUMINUM COMPOUNDS USING WASTE SULFURIC ACID AND METHOD THEREOF

(71) Applicant: MG CHEM CO., LTD., Tainan City (TW)

(72) Inventor: I Jen Hsiao, Tainan City (TW)

(21) Appl. No.: 19/390,549

(22) Filed: Nov. 15, 2025

(30) Foreign Application Priority Data
Nov. 26, 2024 (TW) 113145764

(51) Int. Cl. C01F 7/762

(52) U.S. Cl. CPC C01F 7/762

(57) ABSTRACT

A system for preparing aluminum compounds using waste sulfuric acid and a method thereof are disclosed. The system includes a storage tank, a first reaction tank, an impurity removal device, a second reaction tank, an evaporator, and a crystallizer. The storage tank supplies a waste sulfuric acid solution to the first reaction tank. The waste sulfuric acid solution reacts with an aluminum source to obtain an aluminum sulfate solution. The aluminum sulfate solution is directed to the evaporator to be concentrated into a saturated solution and then cooled and crystallized; or the waste sulfuric acid solution is delivered to the second reaction tank after impurities are removed, mixed with a sulfate to obtain an aluminum sulfate double salt solution. The aluminum sulfate double salt solution is evaporated and concentrated, and then cooled and crystallized.

### FIELD OF THE INVENTION

The present invention relates to a system for preparing aluminum compounds and a method thereof, and more particularly to a system for preparing aluminum compounds using waste sulfuric acid and a method thereof.

### BACKGROUND OF THE INVENTION

Sulfuric acid is commonly used in industrial production. In an era where the circular economy prevails, how to handle waste sulfuric acid solutions generated after production and use is a matter of great concern to the industry. Taiwan's semiconductor industry is booming. High-concentration sulfuric acid is often used for etching when preparing wafers. The large amount of waste sulfuric acid produced after use still has an extremely high concentration. It is still a usable raw material for the steel and metal industry. Therefore, it can be recycled and supplied for use in other industries. However, the current output of waste sulfuric acid in the semiconductor industry far exceeds domestic market demands. Besides, waste sulfuric acid produced by other industries has a relatively low concentration and is not suitable for use in metal processing. How to reasonably recycle and utilize the above-mentioned waste sulfuric acid solution has become an urgent problem to be solved. Therefore, it is necessary to establish new and robust recycling channels to address the issue of excess waste sulfuric acid generated domestically.

Aluminum sulfate, produced using sulfuric acid as one of its raw materials, is often used as a flocculant in industrial applications to purify drinking water and in sewage treatment equipment, achieving the effect of adsorption purification. Aluminum sulfate double salts such as potassium aluminum sulfate, sodium aluminum sulfate and ammonium aluminum sulfate are commonly used in various industries. For example, potassium aluminum sulfate is used for water purification and leather tanning. Sodium aluminum sulfate is used as a food acidity regulator, primarily in the production of baking powder. Ammonium aluminum sulfate is used in water purification, porcelain and cement manufacturing, leather production, fire-retardant fabrics, and as an antibacterial agent in cosmetics. Aluminum sulfate and its double salts have a wide range of applications. Utilizing the large amount of waste sulfuric acid produced domestically to prepare aluminum sulfate and its double salts not only meets market demand for these products but also effectively recycles waste sulfuric acid, reducing its discharge and complying with green environmental protection requirements.

However, existing systems in the industry for producing aluminum sulfate using waste sulfuric acid solutions are functionally limited. They cannot simultaneously meet the demands for producing aluminum sulfate and its double salts, resulting in a narrow range of finished products that fail to satisfy the diverse needs of the market. This is an urgent problem that needs to be solved at the present stage.

### SUMMARY OF THE INVENTION

The primary object of the present invention is to provide a system for preparing aluminum compounds using waste sulfuric acid, which diversifies finished products derived from a waste sulfuric acid solution, meets various market demands, conforms to the circular economy and enhances the economic utilization value of waste sulfuric acid.

Another object of the present invention is to provide a method for preparing aluminum compounds using waste sulfuric acid by using the foregoing system, which utilizes the continuity of the reaction to obtain different reaction products, meeting the diverse demands of the market and enhancing the economic utilization value of waste sulfuric acid.

According to one aspect of the present invention, a system for preparing aluminum compounds using waste sulfuric acid comprises a storage tank, a first reaction tank, a second reaction tank, an evaporator, a crystallizer, a crushing device, and a screening device.

The storage tank is configured for storing and supplying a waste sulfuric acid solution.

The first reaction tank communicates with the storage tank via a first feed pipe for receiving the waste sulfuric acid solution. An aluminum source is added into the first reaction tank. The aluminum source reacts with the waste sulfuric acid solution to form an aluminum sulfate solution. The first reaction tank further communicates with a delivery pipe and an impurity removal via a first discharge pipe, thereby directing the aluminum sulfate solution to the delivery pipe or the impurity removal device. The impurity removal device is configured for removing insoluble impurities from the aluminum sulfate solution.

The second reaction tank communicates with the impurity removal device via a second feed pipe for receiving the aluminum sulfate solution from which the insoluble impurities have been removed. A sulfate is added and mixed with the aluminum sulfate solution to form an aluminum sulfate double salt solution.

The evaporator communicates with the delivery pipe and a second discharge pipe of the second reaction tank for evaporating and concentrating the aluminum sulfate solution from the first reaction tank to form a saturated aluminum sulfate solution or for evaporating and concentrating the aluminum sulfate double salt solution from the second reaction tank to form a saturated aluminum sulfate double salt solution.

The crystallizer communicates with the evaporator and the impurity removal device for receiving, cooling and crystallizing the solution from the evaporator or the impurity removal device, thereby obtaining aluminum sulfate crystals or aluminum sulfate double salt crystals.

The crushing device communicates with the crystallizer via a crystal conveying pipe for crushing the aluminum sulfate crystals and the aluminum sulfate double salt crystals.

The screening device communicates with the crushing device via a transport pipe for sorting the crystals with a particle size less than 50 mesh to be recycled as seed crystals back to the crystallizer and the crystals with a particle size greater than 50 mesh to be output as finished products.

According to another aspect of the present invention, a method for preparing aluminum compounds using waste sulfuric acid comprises the following steps:
(a) the waste sulfuric acid solution being quantitatively delivered to the first reaction tank, and subjecting the waste sulfuric acid solution to a hydrogen peroxide (H₂O₂) removal treatment for reducing the hydrogen peroxide content to less than 0.1 wt %;
(b) the amount of the aluminum source to be added being calculated based on a sulfuric acid content of the waste sulfuric acid solution after hydrogen peroxide is removed, and an excess of 1% to 2% of the aluminum source being added to the first reaction tank, the reaction temperature being 70° C. to 150° C., the stirring speed being 40 rpm to 90 rpm, stirring being carried out at a constant temperature and constant speed for 10 minutes to 150 minutes to mature the reaction, the reaction is terminated when the pH value of the reaction solution is from 1 to 4, and the aluminum sulfate content, expressed in terms of aluminum oxide (Al₂O₃), is greater than 14%, thereby obtaining the aluminum sulfate solution;
(c) the aluminum sulfate solution is subjected to a treatment for obtaining aluminum compound crystals.6. The method as claimed in claim 5, wherein in the step (a), the sulfuric acid content of the waste sulfuric acid solution is 40 wt % to 98 wt %.

### BRIEF DESCRIPTION OF THE DRAWINGS

FIG. 1 is a block diagram of a system for preparing aluminum compounds using waste sulfuric acid according to an embodiment of the present invention;

FIG. 2 is a block diagram of a system for preparing aluminum compounds using waste sulfuric acid according to the first embodiment of the present invention;

FIG. 3 is a block diagram of a system for preparing aluminum compounds using waste sulfuric acid according to the second embodiment of the present invention;

FIG. 4 is a flow chart of a method for preparing aluminum compounds using waste sulfuric acid according to an embodiment of the present invention; and

FIG. 5 is a flow chart of a method for preparing aluminum compounds using waste sulfuric acid according to another embodiment of the present invention.

### DETAILED DESCRIPTION OF THE PREFERRED EMBODIMENTS

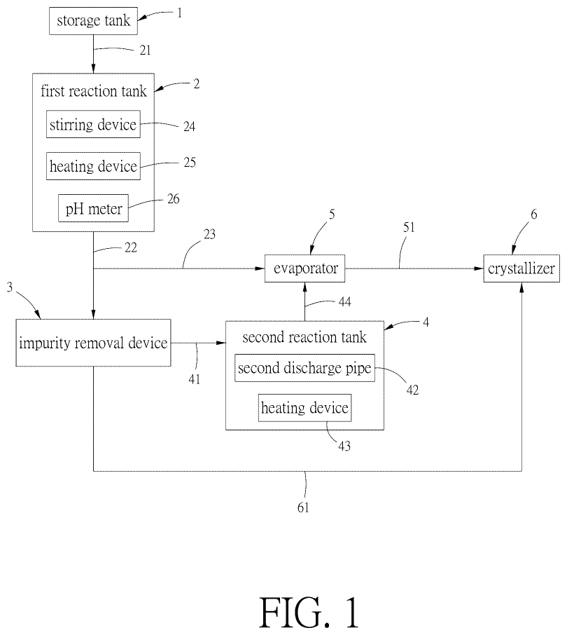

Referring to FIG. 1, a system for preparing aluminum compounds using waste sulfuric acid according to a preferred embodiment of the present invention comprises a storage tank 1, a first reaction tank 2, an impurity removal 3, a second reaction tank 4, an evaporator 5, and a crystallizer 6.

The storage tank 1 communicates with a first feed pipe 21 of the first reaction tank 2 for storing and quantitatively supplying a waste sulfuric acid solution to the first reaction tank 2. The waste sulfuric acid solution mainly originates from the semiconductor industry, with a sulfuric acid content ranging from 40 wt % to 98 wt %.

An aluminum source is added into the first reaction tank 2. The aluminum source reacts with the waste sulfuric acid solution to form an aluminum sulfate solution. The first reaction tank 2 communicates with a delivery pipe 23 and the impurity removal 3 via a first discharge pipe 22, thereby directing the aluminum sulfate solution to the delivery pipe 23 or the impurity removal device 3. The impurity removal device 3 is configured for removing insoluble impurities from the aluminum sulfate solution. Specifically, the impurity removal device 3 removes insoluble impurities by means of sedimentation or filtration. A gravity sedimentation device or a plate-and-frame filter press may be used. In this embodiment, a plate-and-frame filter press is used.

The first reaction tank 2 further includes a stirring device 24, a heating device 25, and a pH meter 26. The heating device 25 controls the reaction temperature. The stirring device 24 stirs and mixes the waste sulfuric acid solution with the aluminum source to ensure thorough reaction, accelerating the dissolution of the aluminum source in the waste sulfuric acid solution. The pH meter 26 is configured for measuring the pH value of the reaction solution. The reaction reaches completion when the pH value of the reaction solution is between 1 and 4. The aluminum source is one of kaolin, bauxite, aluminum hydroxide and aluminum oxide.

The second reaction tank 4 communicates with the impurity removal device 3 via a second feed pipe 41 for receiving the aluminum sulfate solution from which the insoluble impurities have been removed. A sulfate is added into the second reaction tank 4. The sulfate is potassium sulfate, sodium sulfate or ammonium sulfate. The sulfate is mixed with the aluminum sulfate solution to form an aluminum sulfate double salt solution. The second reaction tank 4 includes a stirring device 42 and a heating device 43 for controlling the reaction temperature and the stirring speed to ensure that the sulfate is completely dissolved in the aluminum sulfate solution.

The evaporator 5 communicates with the delivery pipe 23 and a second discharge pipe 44 of the second reaction tank 4 for evaporating and concentrating the aluminum sulfate solution from the first reaction tank 2 to form a saturated aluminum sulfate solution or for evaporating and concentrating the aluminum sulfate double salt solution from the second reaction tank 4 to form a saturated aluminum sulfate double salt solution. The saturated solution obtained by means of concentration is delivered from the evaporator 5 to the crystallizer 6 via a connecting pipe 51. The crystallizer 6 communicates with the impurity removal device 3 via a conveying pipe 61. The solution from the evaporator 5 or the impurity removal device 3 is cooled and crystallized by natural cooling or forced cooling. The crystallizer 6 is a screw crystallizer, a belt crystallizer or a tubular crystallizer. The crystallizer 6 separates the crystals from the mother liquor to obtain aluminum sulfate crystals or aluminum sulfate double salt crystals. The aluminum sulfate double salt crystals are potassium aluminum sulfate crystals, sodium aluminum sulfate crystals or ammonium aluminum sulfate crystals.

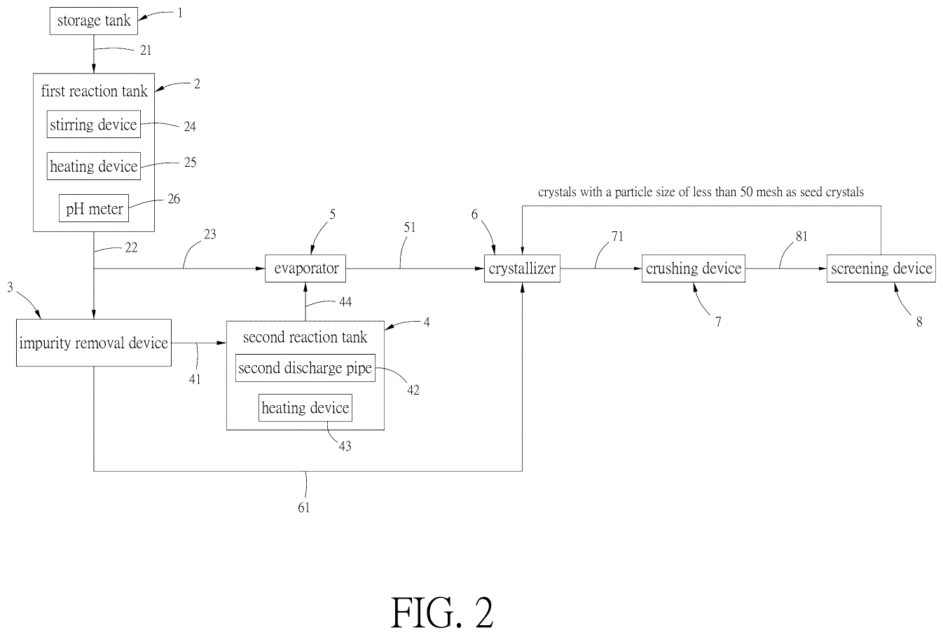

The first feasible embodiment of the present invention, as shown in FIG. 2, further comprises a crushing device 7 and a screening device 8. The crushing device 7 communicates with the crystallizer 6 via a crystal conveying pipe 71 and is configured for crushing the aluminum sulfate crystals and the aluminum sulfate double salt crystals according to the particle size required by the market. The crushed crystals are conveyed to the screening device 8 via a transport pipe 81. The crystals with a particle size less than 50 mesh are sorted as seed crystals and sent back to the crystallizer 6, and the crystals with a particle size greater than 50 mesh are output as finished products. The products are packaged and sold according to commercial specifications.

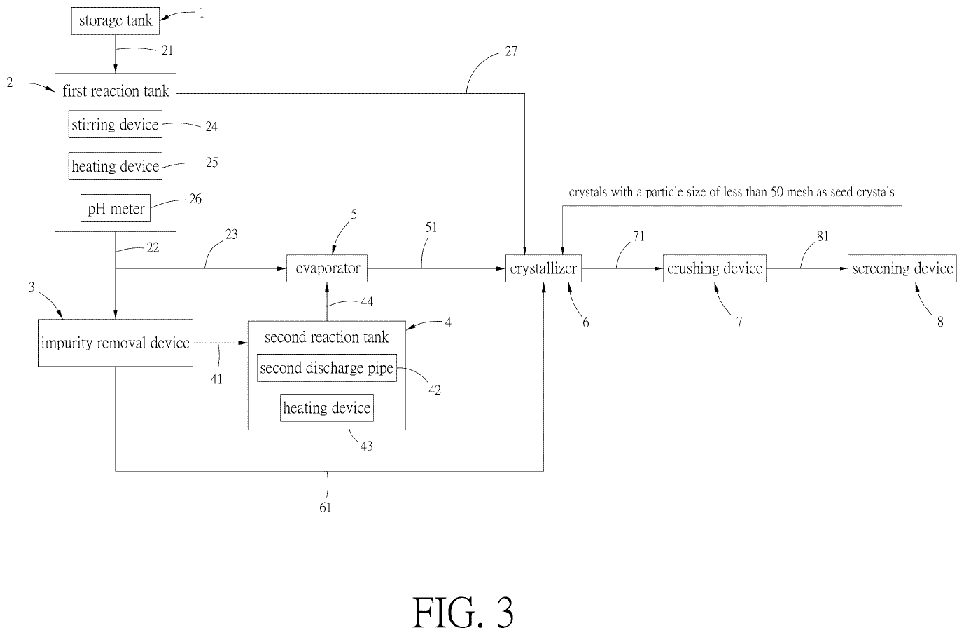

The second feasible embodiment of the present invention, as shown in FIG. 3, the first reaction tank 2 is further communicated with the crystallizer 6 via a third discharge pipe 27 for directing the aluminum sulfate solution to the crystallizer 6.

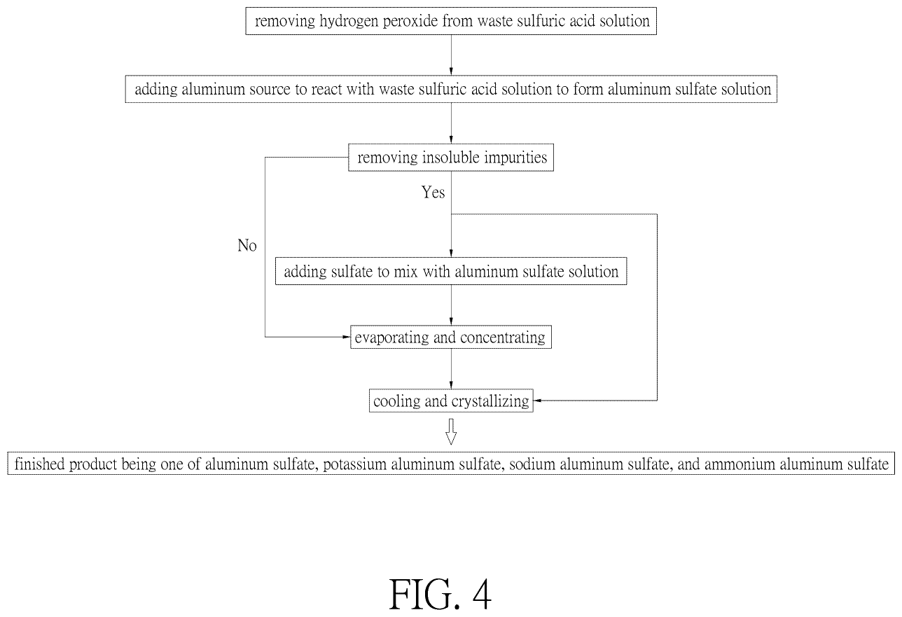

As shown in FIG. 4, the method using the system for preparing aluminum compounds of the present invention comprises the following steps:
(a) the waste sulfuric acid solution is quantitatively delivered to the first reaction tank 2 and subjecting the waste sulfuric acid solution to a hydrogen peroxide (H₂O₂) removal treatment for reducing the hydrogen peroxide content to less than 0.1 wt %.

Wherein, the hydrogen peroxide removal treatment comprises directly heating the waste sulfuric acid solution to 60° C. to 120° C. to decompose hydrogen peroxide (H₂O₂), or quantitatively metering an oxidant for reaction to decompose hydrogen peroxide. The sulfuric acid content of the waste sulfuric acid solution is 40 wt % to 98 wt %. If the sulfuric acid content is lower than 40 wt %, additional sulfuric acid is added to reach the required content for the reaction. This step utilizes the principle of hydrogen peroxide decomposition when heated. By directly increasing the temperature or reacting sulfuric acid with the oxidant to release heat, the decomposition of hydrogen peroxide is accelerated to remove the residual hydrogen peroxide in the waste sulfuric acid solution. On the one hand, this prevents the risk of sudden boiling in the subsequent reaction process, thereby avoiding production safety hazards. On the other hand, it prevents hydrogen peroxide from causing discoloration of aluminum sulfate. After the reaction is completed, the residual amount of hydrogen peroxide in the waste sulfuric acid solution is tested with hydrogen peroxide test paper to ensure that hydrogen peroxide is fully removed.

Specifically, the oxidant is nitric acid, aluminum powder, aluminum chips aluminum materials or aluminum hydroxide. The amount of nitric acid added is 500 ppm to 800 ppm by weight of the waste sulfuric acid solution. The amount of the aluminum powder, aluminum chips, aluminum materials or aluminum hydroxide added is in the range of 0.1% to 6% by weight of the waste sulfuric acid solution. To ensure that hydrogen peroxide is fully decomposed by heating, the heating device of the first reaction tank maintains the reaction temperature above 60° C., and the stirring speed of the stirring device is 30 rpm to 80 rpm. The stirring is carried out at a constant temperature and constant speed for 30 minutes to remove hydrogen peroxide from the waste sulfuric acid solution. The decomposition reaction formula of hydrogen peroxide is:

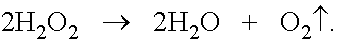

(b) The amount of the aluminum source to be added is calculated based on the sulfuric acid content of the waste sulfuric acid solution after hydrogen peroxide is removed, and an excess of 1% to 2% of the aluminum source is added to the first reaction tank. The aluminum source is one of kaolin, bauxite, aluminum hydroxide and aluminum oxide. The heating device of the first reaction tank further controls the reaction temperature to be 70° C. to 150° C. The stirring speed of the stirring device is 40 rpm to 90 rpm. The stirring is carried out at a constant temperature and constant speed for 10 minutes to 150 minutes to mature the reaction. the reaction is terminated when the pH value of the reaction solution is from 1 to 4, and the aluminum sulfate content, expressed in terms of aluminum oxide (Al₂O₃), is greater than 14%, thereby obtaining the aluminum sulfate solution. The main reaction formula is

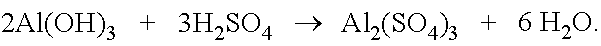

(c) the aluminum sulfate solution is subjected to a treatment for obtaining aluminum compound crystals. Wherein, the treatment comprises conveying the aluminum sulfate solution to the crystallizer 6 for cooling and crystallization to obtain aluminum sulfate crystals. When aluminum hydroxide is employed as the aluminum source, the reaction solution contains only a small amount of insoluble impurities. After the solution is allowed to stand in the first reaction tank 2 for settling, it can be directly conveyed to the crystallizer 6, where it is cooled to induce crystallization of aluminum sulfate. This approach avoids the need for additional impurity removal steps prior to crystallization.

The treatment also comprises evaporating the aluminum sulfate solution at a temperature of 80° C. to 150° C., and concentrating by 30% to 50% in the evaporator 5, and then being cooled and crystallized in the crystallizer 6, thereby obtaining the aluminum sulfate crystals.

In another embodiment, the treatment comprises removing the insoluble impurities from the aluminum sulfate solution via the impurity removal device 3 by means of gravity sedimentation or filtration, and then cooling and crystallizing the aluminum sulfate solution in the crystallizer 6, thereby obtaining the aluminum sulfate crystals.

Alternatively, the treatment also comprises removing the insoluble impurities from the aluminum sulfate solution, delivering the aluminum sulfate solution to the second reaction tank 4, and adding the sulfate to the second reaction tank 4, the reaction temperature is 60° C. to 130° C., the stirring speed is 40 rpm to 90 rpm, the stirring being carried out at a constant temperature and constant speed for 30 minutes to 180 minutes to obtain the aluminum sulfate double salt solution, the aluminum sulfate double salt solution is then concentrated by 40% to 50% at 90° C. to 160° C. in the evaporator 5, and subsequently cooled and crystallized in the crystallizer to obtain the aluminum sulfate double salt crystals. The sulfate is one of potassium sulfate, sodium sulfate and ammonium sulfate. The amount of the sulfate added accounts for 50% to 85% by weight of the aluminum sulfate solution. Any of the above sulfates is dissolved in the aluminum sulfate solution and crystallized by cooling to form double salts containing crystal water with the aluminum sulfate. The specific reaction formula for sulfate and aluminum sulfate to form double salts is as follows:

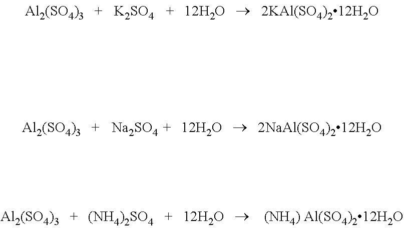

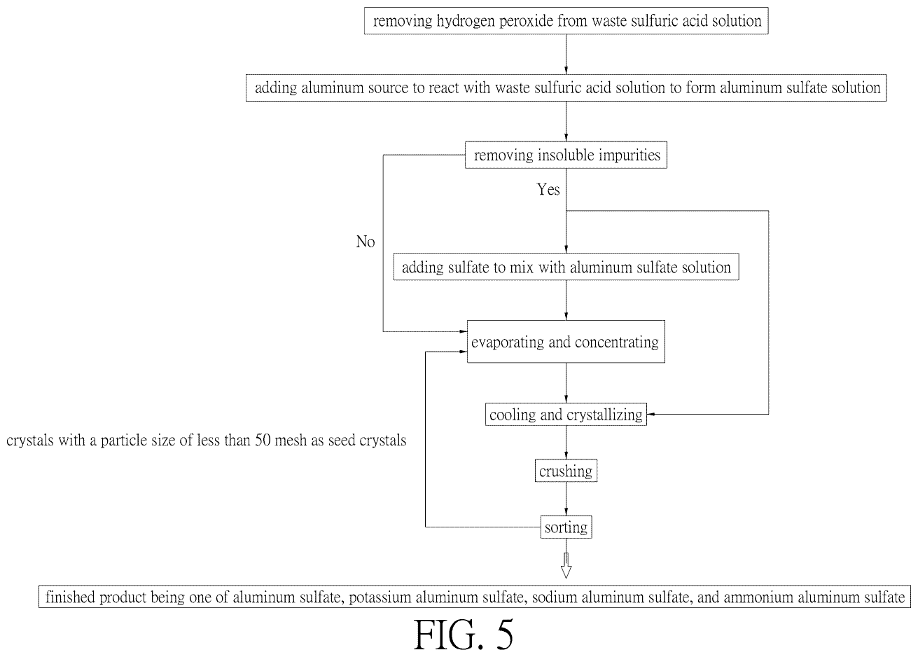

As shown in FIG. 5, in another possible embodiment of the present invention, the method further comprises the following step after step (c):
(d) The aluminum sulfate crystals or the aluminum sulfate double salt crystals are crushed, and the crystals with a particle size of less than 50 mesh are sorted as seed crystals, and the crystals with a particle size greater than 50 mesh are output as finished products to meet market demands.

The technical content of the present invention is further illustrated with reference to the following Example 1 and Example 2. In both Example 1 and Example 2, waste sulfuric acid solution discharged from the semiconductor industry is used as the experimental sample. The system and method for preparing aluminum compounds using waste sulfuric acid provided by the present invention are used to prepare aluminum sulfate and aluminum sulfate double salt. The specific process is as follows:

### Example 1

### (1) Reactant and Reagent

waste sulfuric acid solution: waste sulfuric acid solution containing approximately 5% hydrogen peroxide (H₂O₂) originated from the semiconductor industry, with an 80% sulfuric acid content.
oxidant: nitric acid
aluminum source: kaolin
sulfate: potassium sulfate

### (2) the Steps for Preparing Aluminum Sulfate:

Step 1: the waste sulfuric acid solution from the storage tank is quantitatively delivered to the first reaction tank, and nitric acid with a weight ratio of 500 ppm is quantitatively added to the waste sulfuric acid solution using a metering device. The heating device raises the reaction temperature to 65° C. and maintains it. After the stirring device continues stirring at 50 rpm for 35 minutes, The waste sulfuric acid solution with hydrogen peroxide removed is obtained when the hydrogen peroxide content in the waste sulfuric acid solution is determined to be below 0.1 wt %;
Step 2: based on the sulfuric acid content of the waste sulfuric acid solution processed in step 1, an excess of 1.5% kaolin is added to the first reaction tank, and the reaction temperature is further controlled at 80° C. The stirring speed is 70 rpm. The stirring is carried out at a constant temperature and constant speed for 120 minutes to mature the reaction. The reaction reaches completion when the pH value of the reaction solution is monitored by the pH meter and reaches 3, and the aluminum sulfate content, expressed in terms of aluminum oxide (Al₂O₃), is 14.8%, obtaining the aluminum sulfate solution;
Step 3: after the aluminum sulfate solution is evaporated and concentrated by 50% at 80° C. in the evaporator, the aluminum sulfate solution is cooled and crystallized in the crystallizer to separate the aluminum sulfate crystals and its mother liquor;

### (3) the Steps for Preparing Potassium Aluminum Sulfate:

Step 4: after the impurity removal device removes the insoluble impurities from the aluminum sulfate solution processed in step 2, the clarified aluminum sulfate solution is delivered to the second reaction tank. 75% potassium sulfate by weight of the aluminum sulfate solution is added to the second reaction tank through a feeder. The temperature is kept at 80° C. The stirring speed is 80 rpm. The mixture is stirred for 45 minutes until the potassium sulfate is completely dissolved. The mixed solution is evaporated and concentrated by 40% in the evaporator, and then cooled and crystallized in the crystallizer to separate potassium aluminum sulfate crystals and its mother liquor.

### Example 2

### (1) Reactant and Reagent

waste sulfuric acid solution: waste sulfuric acid solution containing approximately 4% hydrogen peroxide (H₂O₂) originated from the semiconductor industry, with a 76% sulfuric acid content.
oxidant: aluminum powder
aluminum source: aluminum hydroxide
sulfate: sodium sulfate

### (2) the Steps for Preparing Aluminum Sulfate:

Step 1: the waste sulfuric acid solution from the storage tank is quantitatively delivered to the first reaction tank, and aluminum powder with a weight ratio of 6% of the waste sulfuric acid solution is quantitatively added using a metering device. The heating device raises the reaction temperature to 60° C. and maintains it. After the stirring device continues stirring at 62 rpm for 40 minutes, The waste sulfuric acid solution with hydrogen peroxide removed is obtained when the hydrogen peroxide content in the waste sulfuric acid solution is determined to be below 0.1 wt %;
Step 2: based on the sulfuric acid content of the waste sulfuric acid solution processed in step 1, an excess of 2% aluminum hydroxide is added to the first reaction tank, and the reaction temperature is controlled at 70° C. The stirring speed is 40 rpm. The stirring is carried out at a constant temperature and constant speed for 150 minutes to mature the reaction. The reaction reaches completion when the pH value of the reaction solution is monitored by the pH meter and reaches 2, and the aluminum sulfate content, expressed in terms of aluminum oxide (Al₂O₃), is 14.8%, obtaining the aluminum sulfate solution;
Step 3: after the aluminum sulfate solution is evaporated and concentrated by 40% at 70° C. in the evaporator, the aluminum sulfate solution is cooled and crystallized in the crystallizer to separate the aluminum sulfate crystals and its mother liquor;
Step 4: after the aluminum sulfate crystals are crushed by the crushing device, the crushed aluminum sulfate crystals are sorted by the screening device. The crystals with a particle size less than 50 mesh are used as seed crystals, and the crystals with a particle size greater than 50 mesh are output as finished products.

### (3) the Steps for Preparing Potassium Aluminum Sulfate:

Step 5: the aluminum sulfate solution processed in step 2 is filtered by the impurity removal device to remove the insoluble impurities and then delivered to the second reaction tank. 80% sodium sulfate by weight of the aluminum sulfate solution is added to the second reaction tank through a feeder. The temperature is kept at 65° C. The stirring speed is 70 rpm. The mixture is stirred for 60 minutes until the sodium sulfate is completely dissolved, obtaining a sodium aluminum sulfate solution. The sodium aluminum sulfate solution is evaporated and concentrated by 50% in the evaporator, and then cooled and crystallized in the crystallizer to separate the sodium aluminum sulfate crystals and its mother liquor.
Step 6: after the sodium aluminum sulfate crystals are crushed by the crushing device, the crushed sodium aluminum sulfate crystals are sorted by the screening device, the crystals with a particle size less than 50 mesh are used as seed crystals, and the crystals with a particle size greater than 50 mesh are output as finished products.

### Example 3

### (1) Reactant and Reagent

waste sulfuric acid solution: waste sulfuric acid solution containing approximately 4% hydrogen peroxide (H₂O₂) originated from the semiconductor industry, with a 46% sulfuric acid content.
aluminum source: aluminum hydroxide

### (2) the Steps for Preparing Aluminum Sulfate:

Step 1: the waste sulfuric acid solution from the storage tank is quantitatively delivered to the first reaction tank. The waste sulfuric acid solution is directedly heated to 100° C. After the stirring device continues stirring at 30 rpm for 30 minutes, The waste sulfuric acid solution with hydrogen peroxide removed is obtained when the hydrogen peroxide content in the waste sulfuric acid solution is determined to be below 0.1 wt %;
Step 2: based on the sulfuric acid content of the waste sulfuric acid solution processed in step 1, an excess of 2% aluminum hydroxide is added to the first reaction tank, and the reaction temperature is controlled at 115° C. The stirring speed is 40 rpm. The stirring is carried out at a constant temperature and constant speed for 30 minutes to mature the reaction. The reaction reaches completion when the pH value of the reaction solution is monitored by the pH meter and reaches 3, and the aluminum sulfate content, expressed in terms of aluminum oxide (Al₂O₃), is 15.2%, obtaining the aluminum sulfate solution;
Step 3: after stirring stops in the first reaction tank, the aluminum sulfate solution undergoes gravity settling. The clarified liquid is then delivered to a belt crystallizer, where it is cooled and crystallized to obtain the aluminum sulfate crystals.

In summary, the system and method for preparing aluminum compounds using waste sulfuric acid provided by the present invention have the following technical improvements and advantages:
Firstly, aluminum sulfate and aluminum sulfate double salts can be produced simultaneously, shortening the production process. The system provided by the present invention processes the aluminum sulfate solution generated in the first reaction tank in two ways. The first way involves concentrating, cooling and crystallizing the aluminum sulfate solution, thereby obtaining the aluminum sulfate crystals. The second way involves filtering the aluminum sulfate solution, mixing the aluminum sulfate solution with the sulfate, concentrating and crystallizing the mixed solution, thereby obtaining the aluminum sulfate double salts. This eliminates the need to establish an additional aluminum sulfate double salt preparation system, shortening the production process effectively.
Secondly, diversifying the types of finished products of waste sulfuric acid solution treatment to meet diverse market demands. Taking advantage of the commonality and continuity of the reaction, sodium aluminum sulfate, potassium aluminum sulfate or ammonium aluminum sulfate can be prepared by adding sodium sulfate, potassium sulfate or ammonium sulfate to aluminum sulfate solution, increasing the diversity of product types, meeting the market demand for different aluminum compounds and improving the economic utilization value of waste sulfuric acid.
Thirdly, removing hydrogen peroxide from the waste sulfuric acid solution and avoiding safety accidents caused by sudden boiling during the reaction. It also effectively prevents residual hydrogen peroxide from causing discoloration of the aluminum sulfate produced by the reaction, affecting the quality of the finished product.
Fourthly, complying with the requirements of circular economy, energy conservation and carbon reduction. The present invention uses waste sulfuric acid solution produced by the semiconductor industry as a reaction raw material, converting the waste sulfuric acid, which is highly polluting to the environment, into compounds applicable to other industries, reducing energy consumption in waste sulfuric acid treatment, and meeting the requirements of circular economy and energy conservation and carbon reduction.

What is claimed is:

1. A system for preparing aluminum compounds using waste sulfuric acid, comprising:
a storage tank, configured for storing and supplying a waste sulfuric acid solution;
a first reaction tank, communicating with the storage tank via a first feed pipe for receiving the waste sulfuric acid solution, an aluminum source being added into the first reaction tank, the aluminum source reacting with the waste sulfuric acid solution to form an aluminum sulfate solution, the first reaction tank further communicating with a delivery pipe and an impurity removal via a first discharge pipe, thereby directing the aluminum sulfate solution to the delivery pipe or the impurity removal device, the impurity removal device being configured for removing insoluble impurities from the aluminum sulfate solution;
a second reaction tank, communicating with the impurity removal device via a second feed pipe for receiving the aluminum sulfate solution from which the insoluble impurities have been removed, a sulfate being added and mixed with the aluminum sulfate solution to form an aluminum sulfate double salt solution;
an evaporator, communicating with the delivery pipe and a second discharge pipe of the second reaction tank for evaporating and concentrating the aluminum sulfate solution from the first reaction tank to form a saturated aluminum sulfate solution or for evaporating and concentrating the aluminum sulfate double salt solution from the second reaction tank to form a saturated aluminum sulfate double salt solution;
a crystallizer, communicating with the evaporator and the impurity removal device for receiving, cooling and crystallizing the solution from the evaporator or the impurity removal device, thereby obtaining aluminum sulfate crystals or aluminum sulfate double salt crystals;
a crushing device, communicating with the crystallizer via a crystal conveying pipe for crushing the aluminum sulfate crystals and the aluminum sulfate double salt crystals;
a screening device, communicating with the crushing device via a transport pipe for sorting the crystals with a particle size less than 50 mesh to be recycled as seed crystals back to the crystallizer and the crystals with a particle size greater than 50 mesh to be output as finished products.

2. The system as claimed in claim 1, wherein the first reaction tank and the second reaction tank each include a heating device and a stirring device controlling a reaction temperature and a stirring speed.

3. The system as claimed in claim 1, wherein the first reaction tank is further communicated with the crystallizer via a third discharge pipe for directing the aluminum sulfate solution to the crystallizer.

4. The system as claimed in claim 1, wherein the crystallizer is a screw crystallizer, a belt crystallizer or a tubular crystallizer.

5. A method for preparing aluminum compounds using waste sulfuric acid by using the system as claimed in claim 1, comprising the following steps:
(a) the waste sulfuric acid solution being quantitatively delivered to the first reaction tank, and subjecting the waste sulfuric acid solution to a hydrogen peroxide (H₂O₂) removal treatment for reducing the hydrogen peroxide content to less than 0.1 wt %;
(b) the amount of the aluminum source to be added being calculated based on a sulfuric acid content of the waste sulfuric acid solution after hydrogen peroxide is removed, and an excess of 1% to 2% of the aluminum source being added to the first reaction tank, the reaction temperature being 70° C. to 150° C., the stirring speed being 40 rpm to 90 rpm, stirring being carried out at a constant temperature and constant speed for 10 minutes to 150 minutes to mature the reaction, the reaction is terminated when the pH value of the reaction solution is from 1 to 4, and the aluminum sulfate content, expressed in terms of aluminum oxide (Al₂O₃), is greater than 14%, thereby obtaining the aluminum sulfate solution;
(c) the aluminum sulfate solution is subjected to a treatment for obtaining aluminum compound crystals.

6. The method as claimed in claim 5, wherein in the step (a), the sulfuric acid content of the waste sulfuric acid solution is 40 wt % to 98 wt %.

7. The method as claimed in claim 5, wherein in step (a), the hydrogen peroxide removal treatment comprises directly heating the waste sulfuric acid solution to 60° C. to 120° C. to decompose hydrogen peroxide (H₂O₂).

8. The method as claimed in claim 5, wherein in step (a), the hydrogen peroxide removal treatment comprises metering an oxidant into the waste sulfuric acid solution for reaction, a reaction temperature being above 60° C. to decompose hydrogen peroxide; a stirring speed being 30 rpm to 80 rpm, stirring being carried out at a constant temperature and constant speed for 30 minutes to remove hydrogen peroxide from the waste sulfuric acid solution.

9. The method as claimed in claim 8, the oxidant is nitric acid, aluminum powder, aluminum chips, aluminum materials or aluminum hydroxide, and the amount of the nitric acid added is 500 ppm to 800 ppm by weight of the waste sulfuric acid solution, and the amount of the aluminum powder, aluminum chips, aluminum materials or aluminum hydroxide added is in the range of 0.1% to 6% by weight of the waste sulfuric acid solution.

10. The method as claimed in claim 5, wherein in the step (b), the aluminum source is one of kaolin, bauxite, aluminum hydroxide and aluminum oxide.

11. The method as claimed in claim 5, wherein in the step (c), the treatment comprises conveying the aluminum sulfate solution to the crystallizer for cooling and crystallization to obtain aluminum sulfate crystals.

12. The method as claimed in claim 5, wherein in the step (c), the treatment comprises evaporating the aluminum sulfate solution and being concentrated by 30% to 50% in the evaporator, and then being cooled and crystallized in the crystallizer, thereby obtaining the aluminum sulfate crystals.

13. The method as claimed in claim 5, wherein in the step (c), the treatment comprises removing the insoluble impurities from the aluminum sulfate solution and then cooling and crystallizing the aluminum sulfate solution in the crystallizer, thereby obtaining the aluminum sulfate crystals.

14. The method as claimed in claim 5, wherein in step (c), the treatment comprises removing the insoluble impurities from the aluminum sulfate solution, delivering the aluminum sulfate solution to the second reaction tank, and adding the sulfate to the second reaction tank, the reaction temperature is 60° C. to 130° C., the stirring speed is 40 rpm to 90 rpm, the stirring being carried out at a constant temperature and constant speed for 30 minutes to 180 minutes to obtain the aluminum sulfate double salt solution, the aluminum sulfate double salt solution is then concentrated by 40% to 50% in the evaporator, and subsequently cooled and crystallized in the crystallizer to obtain the aluminum sulfate double salt crystals.

15. The method as claimed in claim 14, wherein the sulfate is one of potassium sulfate, sodium sulfate and ammonium sulfate, the amount of the sulfate added accounts for 50% to 85% by weight of the aluminum sulfate solution, and the aluminum sulfate double salt crystals are potassium aluminum sulfate crystals, sodium aluminum sulfate crystals or ammonium aluminum sulfate crystals.

16. The method as claimed in claim 5, further comprising the following step after the step (c):
(d) the aluminum compound crystals being crushed, and the crystals with a particle size of less than 50 mesh being sorted as seed crystals, and the crystals with a particle size greater than 50 mesh being output as finished products.
